(19) United States
(12) Patent Application Publication
(10) Pub. No.: US 2004/0036573 A1
(43) Pub. Date: Feb. 26, 2004

(54) Method and apparatus for providing access to a secure region

(75) Inventors: James J. Fitzgibbon, Batavia, IL (US); Mark L. Karasek, Lombard, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/647,422

(22) Filed: Aug. 25, 2003

Related U.S. Application Data
(63) Continuation of application No. 09/964,966, filed on Sep. 27, 2001, now abandoned.
Application No. 09/964,966 is a continuation of application No. 09/577,336, filed on May 22, 2000, now abandoned.
(60) Provisional application No. 60/175,749, filed on Jan. 12, 2000.

(51) Int. Cl. H04Q 1/00

(52) U.S. Cl. 340/5.64; 340/5.71

(57) ABSTRACT

Apparatus for controlling access to a secure region has an audio transducer. A DTMF decoder is connected to the audio transducer. A processor is connected to the DTMF decoder to receive DTMF signals. A memory is connected to the processor storing a code. The processor compares the stored code to the signal from the DTMF decoder and generates an access enable signal in response thereto. A baseband signal output system for connection to a wall control of a garage door operator and for providing a base signal in response to the access enable signal. A radio frequency transmitter provides a radio frequency signal to a radio frequency receiver of the garage door operator in response to the access signal.

### CROSS REFERENCE TO RELATED APPLICATION

Priority is claimed from U.S. provisional application No. 60/175,749, filed Jan. 12, 2000.

### BACKGROUND OF THE INVENTION

The invention relates in general to a home security system and in particular to a home security system which can be controlled remotely to allow entry to a dwelling.

While local only security systems exist, there are not many systems that exist which will allow entry to a portion or all of the dwelling from a remote signaling system. One of the oldest types of systems, however, which will allow such entry at least to a portion of the dwelling if a remote control garage door operator which typically uses radio frequency transmitters. The RF transmitters emit modulated signals including code modulated signals which when received from a receiver identify the transmitter as an authorized transmitter and open the garage door. Upon obtaining access to the garage further access may be obtained to other portions of the dwelling.

Other nonkeyed systems for obtaining access to dwellings are Weiser lock systems which a transmitter of the type usually use for operating a garage door operator may transmit a signal to a door lock of the type provided by the Weiser Company causing the lock to release or become unlocked. The system can cycle a deadbolt from locked to unlocked position and then from unlocked to lock position. It operates at the approximate range of a garage door operator transmitter.

While these systems are convenient to use they nevertheless fail to address several important considerations. One of which is that a person wishing to allow access to the dwelling while the dwelling is unoccupied at particular times of the day. No such systems are presently available other than to leave the door of the dwelling unlock or to request a neighbor to provide access to a package delivery personnel, home maintenance tradesman and the like.

What is needed then in the system which can operate almost over any range to provide immediate access to a home on a remote basis quickly and conveniently.

### SUMMARY OF THE INVENTION

The present invention is embodied in an apparatus for receiving audio signal of the DTMF type and supplying it to a DTMF decoder. The DTMF decoder supplies a decoded signal to a microcontroller which in turn is connected to non-volatile memory having codes stored therein. The code may be learned automatically via a variety of channels such as an RF channel, an Internet channel or the like. The system in one embodiment matches the DTMF code to the stored code and the microcontroller provides an access output signal in response thereto. The access output signal is sent both to a wall control signal generator as well as to an RF transmitter. They then supply output signals respectively available for a wall controller and for a radio receiver of a garage door operator.

In addition this system has a phone network connection, a pager network connection, and an Internet connection for providing pre-authorized remote access signals to the system and also for providing access state output signals to the user at a remote location to indicate that a delivery has been made, a child has arrived home safely or the like.

It is a principle aspect of the present invention to provide an apparatus for remotely enabled and locally enabled access to a dwelling which is simple and easy to use and in which remotely enabled pre-authorized access to be provided or withdrawn in real time.

Other aspects and advantages of the present invention will become obvious to one of ordinary skill in the art upon review of the following specification and claims in light of the accompanying drawings.

### BRIEF DESCRIPTION OF THE DRAWINGS

FIG. 1 is a block diagram of an access system for providing access to a dwelling;

FIG. 2 is a block diagram showing further detail of the access system of FIG. 1;

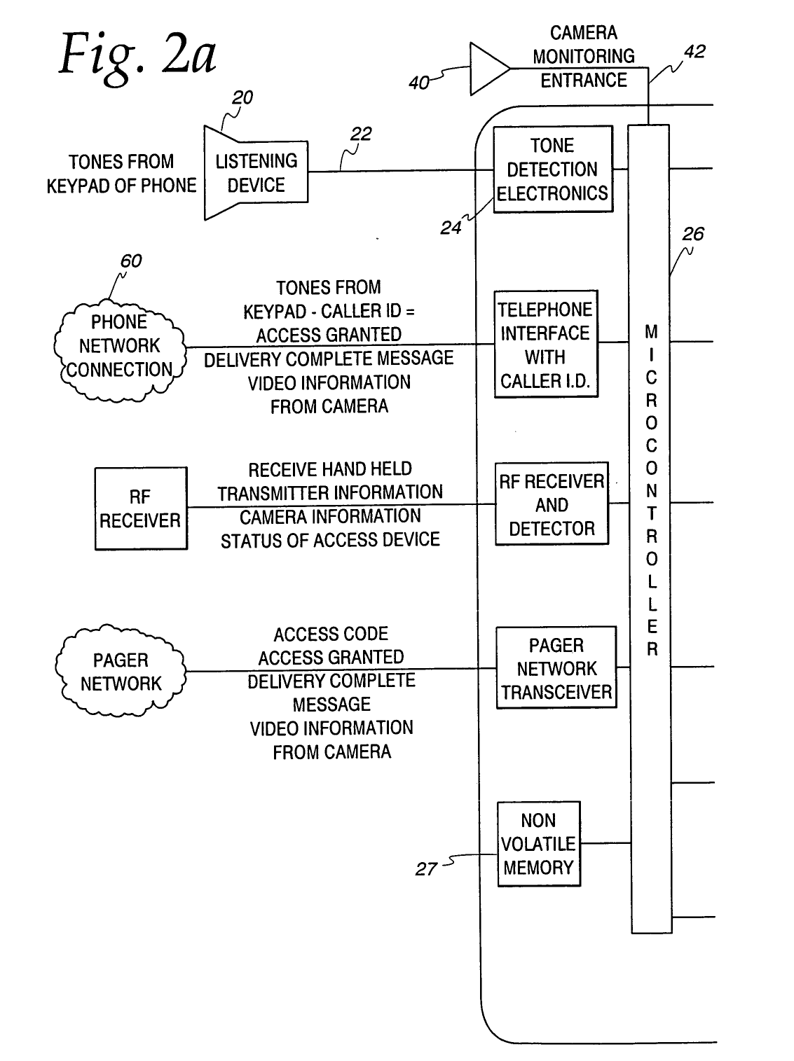

FIG. 3 is a block diagram of another embodiment of the present invention;

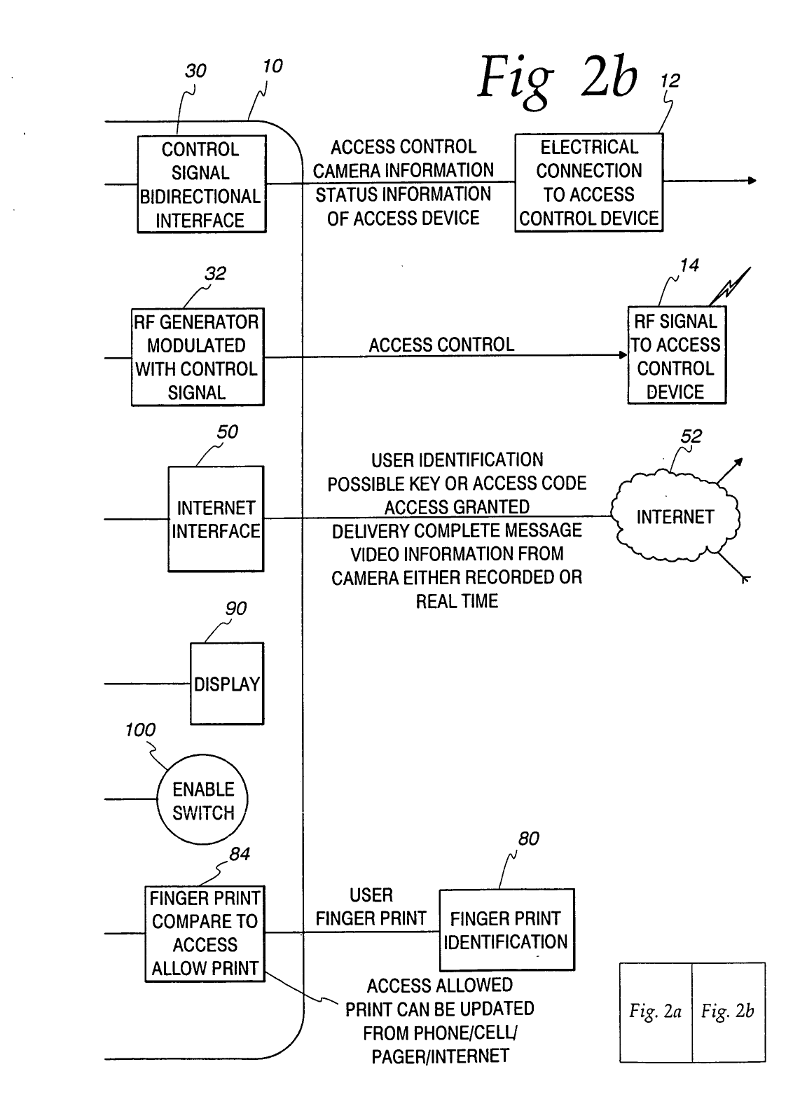

FIG. 4 is a block diagram of a third embodiment of the present invention;

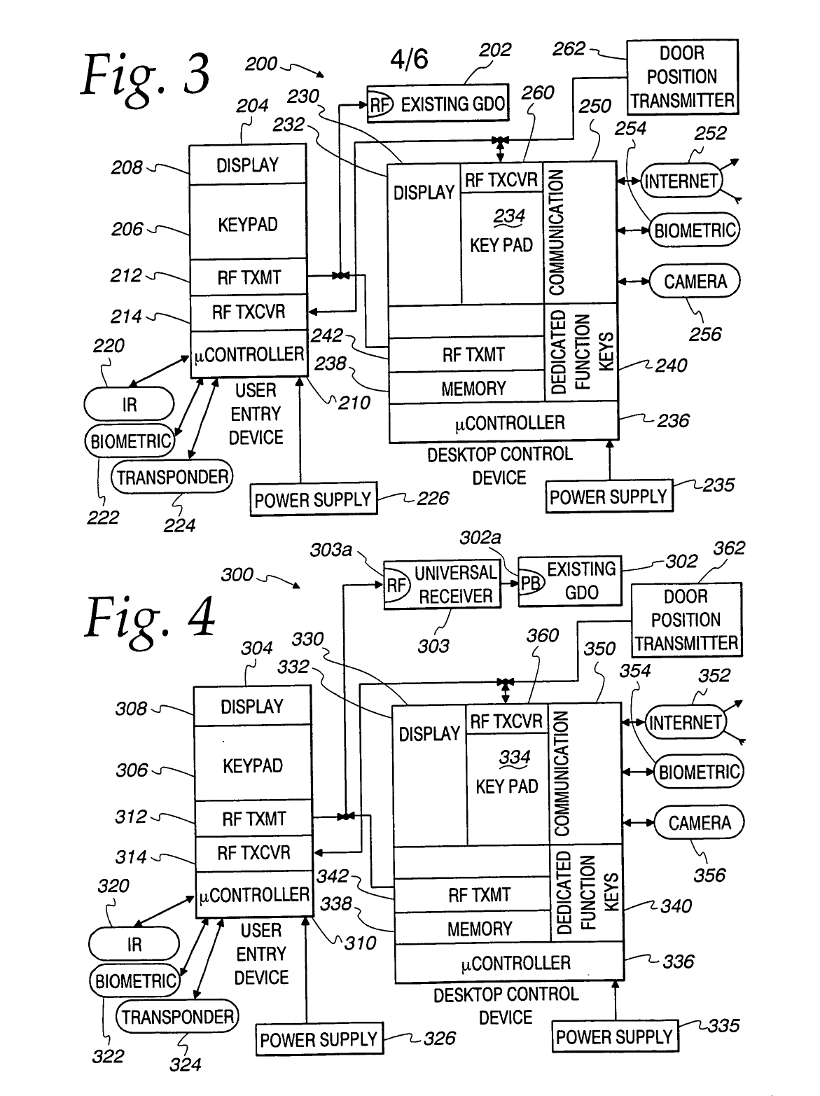

FIG. 5 is a block diagram of a fourth embodiment of the present invention; and

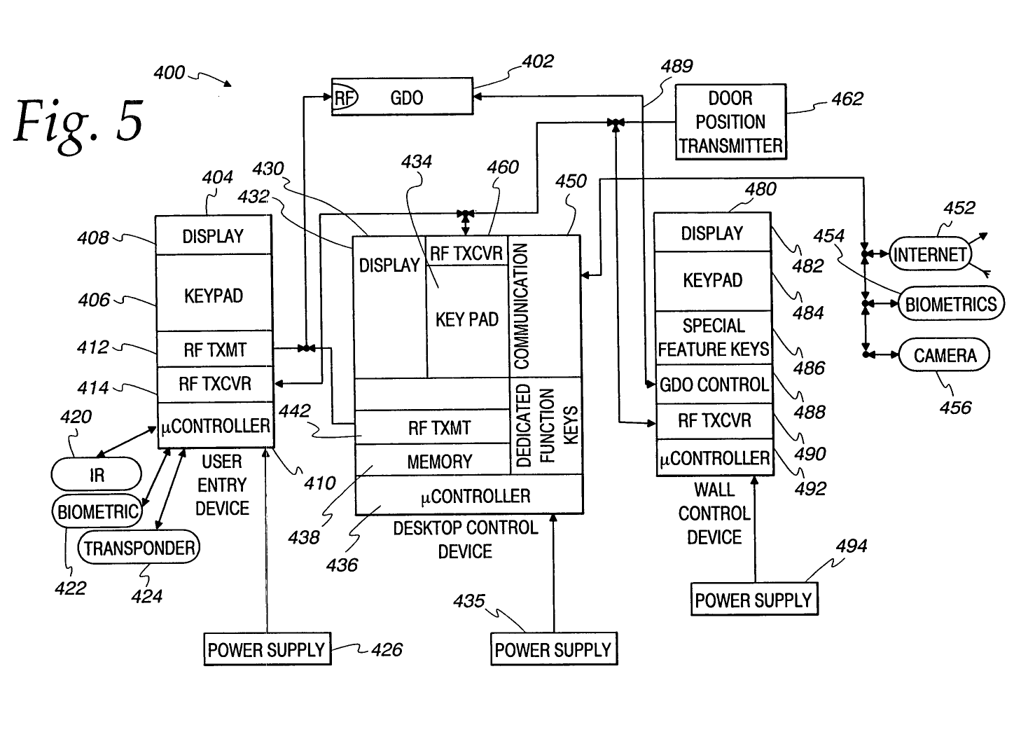

FIG. 6 is a block diagram of a fifth embodiment of the present invention.

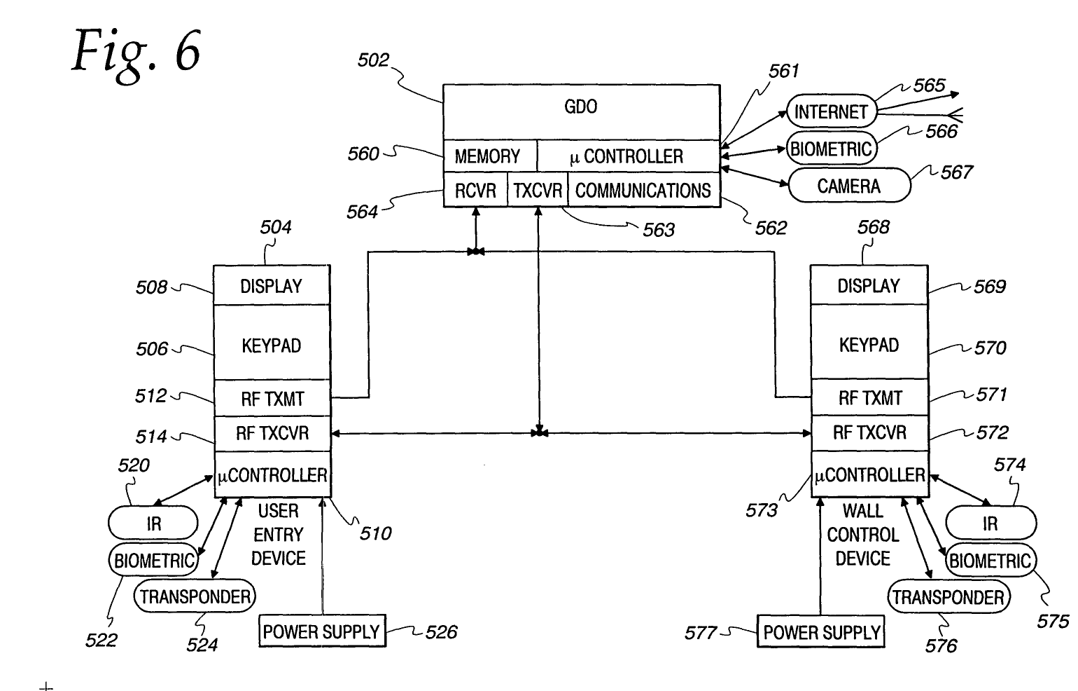

### DETAILED DESCRIPTION OF THE PREFERRED EMBODIMENTS

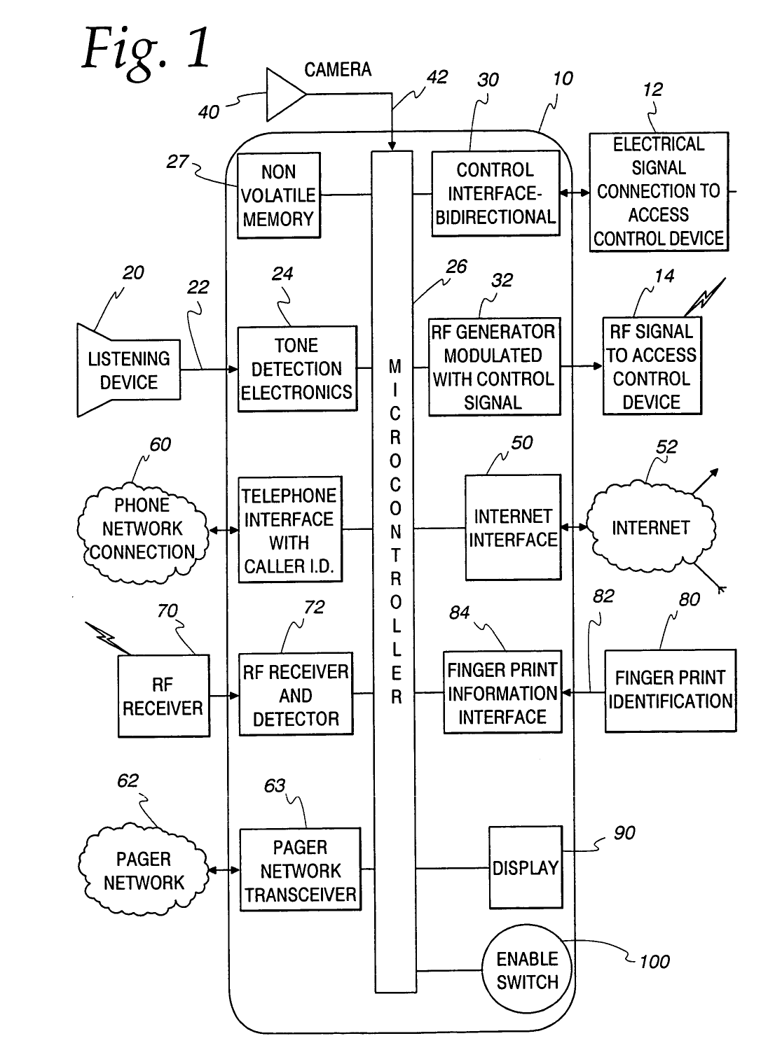

Referring now to the drawings and especially to FIG. 1, an apparatus embodying the present invention is generally shown therein and identified by numeral 10. The apparatus 10 is an electronic apparatus for providing access to a dwelling on a remote basis. The apparatus 10 is adaptable and may receive relatively short range signals over a distance of a few inches to a few feet to long range signals which may travel more than half way around the world. The apparatus 10 may, for instance, comprise a portion of or be connected to a garage door operator which will include a motor for operating a door. The system includes an electrical output port 12 and a radio frequency output port 14. The electrical output port 12 may be part of a baseband signal output system and may provide electrical signals such as baseband signals that are compatible with, for instance, a wall controller of a garage door operator. A radio frequency output port 14 may provide radio frequency signals, for instance, from an antenna which would be received by the receiving antenna of a garage door operator located a short distance away, for instance, within the garage or immediate adjacent to the garage.

In order to actuate the device in a preferred embodiment a listening device such as a microphone 20 is connected by a line 22 to electronics 24 which are conventional and which may be used for the detection of DTMF type signals of the type which might be emitted in an audio stream from a DTMF encoder of the type which might be included for instance in a cellular telephone. No electrical connection need be made between the microphone 20 and the DTMF encoder. It merely needs to “hear” the tone codes which are then detected by the detector 24 which forwards the signal to a microcontroller 26 which will then interpret the tone codes as a code and send a signal to a control interface (or electrical access control)30 such as a baseband signal output system or to an RF generator 32 to provide the RF access signal at the unit 14.

The unit may also include a video camera such as a CCD camera 40 connected via a cable 42 to the microcontroller 26. This would provide an input indication to the microcontroller 26 as to the presence of an individual and may also be used to send a video signal from the camera via a packet switched network interface 50 to an Internet or intranet 52 which may remotely supply information about the person attempting to gain access to the garage door or other portions of the interior of the dwelling.

While it is often desirable in order to conform with standards making bodies such as Underwriters Laboratory to only provide final access authorization through a channel which can only be locally accessed requiring a person to be within a very short distance for instance of the garage door operator. Pre-authorization for that person or class of persons can be provided over a relatively long distance for instance over the Internet. Signals may be received over a phone network connection 60, by pager network connection 62, or from the Internet 52 through the Internet interface 50 being supplied to the microcontroller 26 to provide preauthorization for a subset of persons such as delivery persons and the like in order to limit the likelihood that the system 10 may be spoofed into allowing an unauthorized person to enter the premises.

A radio frequency receiver 70 feeds an RF receiver and detector circuit 72. The radio receiver 70 may be similar to a radio receiver in a garage door operator it may be a super-heterodyne receiver a super regenerative receiver capable of receiving a amplitude modulated, a frequency modulated, a pulse code modulated signal or the like. However, it only receives a relatively short range signal from an RF transmitter such as a garage door operator transmitter. The signal is then supplied to the microcontroller 26 which can compare it with a code stored in non-volatile memory 27 and take action through emitters 12 and 14 to open and close a garage door or a front door of a house or the like.

In addition, another local method of detection is a fingerprint identification system 80 connected 82 to fingerprint system 84 which performs fingerprint processing for identification. It feeds the fingerprint signal to the microcontroller 86 to actuate either the electrical connection access control device 12 or the RF signal access control device 14. A display which might be a liquid crystal display or light emitting display, a vacuum fluorescent display or the like provides a local output to a user to indicate the state of the apparatus 10 for instance to provide information such as enable, disable, etc. The system can also be preprogramed, for instance by a vendor that a package will be received on a certain date and a certain time. The display will indicate that the system has received that message. It also has provided that it remotely, for instance over the Internet, at a phone network connection to the owner of the dwelling. After the authorized person has delivered the package cycling of the controller may be indicated on the display as well and an output indication may be provided via the Internet, phone network, pager network or the like remotely to the person having provided the access authorization to indicate that the transaction was completed.

One advantage of using the local fingerprint identification systems in combination with the remote information transfer channels whether over the phone line, pager network, or the Internet will allow data representative of a particular fingerprint or thumbprint to be transferred from a remote location to the microcontroller 26 and stored in the non-volatile memory 27 in a compressed or uncompressed form. That data would then be used to match with a fingerprint presented to the fingerprint identification device 80. This allows the system to be custom configured on the fly for allowing access to a new temporary user via the fingerprint identification channel. In addition, the system 10 can have permissions provided to it remotely to allow for only a limited number of access or attempts to access via the fingerprint identification channel. That a particular fingerprint will not provide access after the transaction has been completed. Such access can also be limited on a time and date basis through either local loading or remote loading via the Internet or the like.

A further advantage of the system is that the return messaging which can occur over the Internet channel, pager channel, phone network channel or the like allows messages to be sent to the company whose drivers or repair personnel are providing the service. This indicates that the authorized person has arrived at the dwelling at a particular date and time. In this way it allows the service providing company to determine whether the person will be able to complete his or her scheduled tasks for the day or will need to reschedule some for a later time.

In addition, either through the fingerprint channel or the other authorization channels, a child may have authorization to come and go in the house. The system will provide a parent or other authorizing party with information at their office or place of business on a real time basis that the child has arrived home and has been granted admission to the dwelling. This provides parents with a heightened sence of security by knowing on a real time basis that their children have arrived home safely.

Furthermore the apparatus 10 can learn a touch code via the RF channel and store it in the non-volatile memory to provide a temporary touch code simulator function for operating the garage door operator. The temporary code is received during the learn phase from a touch code transmitter after having been placed in learn mode via a signal received over the RF channel.

In a second embodiment of the present invention an apparatus 200 or system 200 may be retrofitted to an existing movable barrier operator or garage door operator 202 of a type which is currently commercially available. The system 200 includes an external keypad unit 204 for monitoring outside a protected area such as a garage having a standard keypad 206 with nine digit keys on it, as well as a liquid crystal display 208 associated with the keypad 204 for displaying information related thereto. A microcontroller 210 is connected to receive key input signals from the keypad 204 and to drive the LCD display 208. A radio frequency transmitter 212 and a radio frequency transceiver 214 are also associated with the keypad 204. The radio frequency transmitter 212 may communicate via fixed or rolling code with the existing garage door operator to provide commands to it through its existing radio frequency receiver. The microcontroller 210 can likewise receive identifying or authorizing inputs from an infrared detector 220, a biometric detector 222, which may include a fingerprint reader, or the like, or a transponder 224 which may be carried on a key fob. The system 200 is driven from a power supply 226 which, in the present embodiment, would be battery operated.

A desktop control device or indoor unit 230 includes a display 232, which may be a liquid crystal display, a video monitor display, or the like. A keypad 234 may provide user input to a microcontroller 236 having on-board memory 238 including RAM and ROM. The user input would control permission and various other control aspects of barrier operator 202. A plurality of dedicated function keys 240 would also be associated with the microcontroller 236 for providing control inputs, which would then be fed to an onboard radio frequency transmitter 242 which can emit coded radio frequency signals for receipt by the existing garage door operator 202. A communication section 250 may communicate with the Internet 252 or other packet switching network, receive signals from a biometric input device 254, such as a fingerprint reader, or the like, or receive signals from a camera 256. A radio frequency transceiver 260 may receive communication from the radio frequency transceiver 214 of the keypad transmitter 204 or from a door-position transmitter 262 associated with a garage door for indicating a position of a garage door to other portions of the access control 200.

In a third embodiment of the present invention an apparatus 300 or system 300 may be attached to an existing movable barrier operator or garage door operator 302 of the type which is currently commercially available. The system 300 includes an external keypad unit 304 having a standard keypad 306 with nine digits on it, as well as a liquid crystal display 308 associated with the keypad 306 for displaying information related thereto. A microcontroller 310 is connected to receive signals from the keypad 306 and to drive the display 308. A radio frequency transmitter 312 and a radio frequency transceiver 314 are also associated with the keypad 304. The radio frequency transmitter 312 may communicate with the existing garage door operator 302 to provide commands to it through its existing radio frequency receiver. The microcontroller 310 can likewise receive inputs from an infrared detector 320, a biometric detector 322, which may include a fingerprint reader, or the like, or a transponder 324 which may be carried on a key fob. The system is driven from a power supply 326 which, in the present embodiment, would be battery operated.

A desktop control device or indoor unit 330 includes a display 332, which may be a liquid crystal display, a video monitor display, or the like. A keypad 334 may provide input to a microcontroller 336 having onboard memory 338 including RAM and ROM. A plurality of dedicated function keys 340 would also be associated with the microcontroller 336 for providing control inputs, which would then be fed to an onboard radio frequency transmitter 342 which can emit coded radio frequency signals for receipt by the existing garage door operator. A communication section 350 may communicate with the Internet 352 or other packet switching network, with a biometric input device 354, such as a fingerprint reader, or the like, or with a camera 356. An authorized user on the Internet could access the barrier operator and change its state and permission levels as well as determine whether the operator is open, closed or in a fault condition. A radio frequency receiver 360 may communicate with the radio frequency transceiver 314 of the keypad transmitter 304 or with a door-position transmitter 362 associated with a garage door for indicating a position of a garage door to other portions of the access control 300.

In a fourth embodiment of the present invention an apparatus 400 or system 400 may be attached to a movable barrier operator on garage door operator 402. The system includes an external keypad unit 404 having a standard keypad 406 with nine digits on it, as well as a liquid crystal display 408 associated with the keypad for displaying information related thereto. A microcontroller 410 is connected to receive signals from the keypad 406 and to drive the display 408. A radio frequency transmitter 412 and a radio frequency transceiver 414 are also associated with the external keypad unit 404. The radio frequency transmitter 412 may communicate with the garage door operator 402 to provide commands to it through its radio frequency receiver. The microcontroller 410 can likewise receive inputs from an infrared detector 420, a biometric detector 422, which may include a fingerprint reader, or the like, or a transponder 424 which may be carried on a key fob. The system is driven from a power supply 426 which, in the present embodiment, would be battery operated.

A desktop control device or indoor unit 430 includes a display 432, which may be a liquid crystal display, a video monitor display, or the like. A keypad 434 may provide input to a microcontroller 436 having onboard memory 438 including RAM and ROM. A plurality of dedicated function keys 440 would also be associated with the microcontroller 436 for providing control inputs, which would then be fed to an onboard radio frequency transmitter 442 which can emit coded radio frequency signals for receipt by the existing garage door operator. A communication section 450 may communicate with the Internet 452 or other packet switching network with a biometric input device 454, such as a fingerprint reader, or the like, or with a camera 456. A radio frequency receiver 460 may communicate with the radio frequency transceiver 414 of the keypad transmitter 404 or with a door-position transmitter 462 associated with a garage door for indicating a position of a garage door to other portions of the access control 400.

In a fifth embodiment of the present invention an apparatus 500 or system 500 includes a movable barrier operator or garage door operator 502. The system 500 also includes a user entry device comprising an external keypad unit 504 having a standard keypad 506 with nine digits on it, as well as a liquid crystal display 508 associated with the keypad for displaying information related thereto. A microcontroller 510 is connected to receive signals from the keypad 506 and to drive the display 508. A radio frequency transmitter 512 and a radio frequency transceiver 514 are also associated with the keypad 504. The radio frequency transmitter 512 may communicate with the existing garage door operator to provide commands to it through its existing radio frequency receiver. The microcontroller can likewise receive inputs from an infrared detector 520, a biometric detector 522, which may include a fingerprint reader, or the like, or a transponder 524 which may be carried on a key fob. The system is driven from a power supply 526 which, in the present embodiment, would be battery operated.

The garage door operator 502 includes a microcontroller 561 having a memory 560 associated with it for storing instructions and operands for execution. The receiver 564 and a radio frequency transmitter 563 are available for communicating with other units including the user entry device 504. The communications unit is also available for providing communications protocols along the microcontroller to communicate remotely with the user via the Internet to receive biometric input signals from a fingerprint reader, retinal reader, or the like, or facial reader 566, or from a camera 567.

In addition to the user entry device 504 which may be located on the outside of the area to which access is to be secured, a wall control device 568 may also be provided which includes a liquid crystal display, or the like, 569 driven by a microcontroller 573. The microcontroller 573 would include RAM memory for holding temporary operands and ROM memory for holding a program, as well as possibly a nonvolatile or flash memory. In addition, transceiver 571 and a radio frequency receiver 572 would be available for communication via radio frequency link either with the user entry device 504 or with the garage door operator 502 allowing display conditions for the garage door operator 502 to be displayed on the display 568, and they may also be on the LCD display 504.

The microcontroller 573 would have connected to it an infrared sensor 574 for determining when persons might be present in the garage or secure area for controlling access to and security aspects thereof. In addition, a biometric reader 575, which might be a fingerprint reader a retinal reader, or a facial scanner, would be available for providing an input to the microcontroller, which would allow the microcontroller to determine whether the garage door operator should be opened or closed depending upon the identity of the person providing the biometric information. A transponder 576 may also communicate with the microcontroller via, ultrasonics, or the like. The transponder 576 may be carried from a key fob, for instance, of user and identify the user to the microcontroller, allowing the user to provide control inputs to the movable barrier operator 502. In addition, a keypad 570 may be used to provide inputs to the movable barrier operator 572. The wall control device 568 would be driven from a power supply 577, which might include AC power or might be driven from battery power.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. Apparatus for electronically controlling access to a secured region comprising:
an audio transducer;
a DTMF decoder;
a processor connected to the DTMF decoder to receive DTMF signals therefrom;
a memory connected to the processor storing a code;
the processor comparing the stored code to the signal from the DTMF decoder and providing an access enable signal in response thereto;
a baseband signal output system for connection to a wall control of a garage door operator and for providing a baseband signal in response to the access enable signal; and
a radio frequency transmitter for providing a radio frequency signal to a radio frequency receiver of the garage door operator in response to said access signal.
